(19) United States
(12) Patent Application Publication
(10) Pub. No.: US 2019/0162862 A1
(43) Pub. Date: May 30, 2019

(54) METHOD FOR LOCATING A VEHICLE, METHOD FOR OPERATING A VEHICLE AS WELL AS SYSTEM

(71) Applicant: TRW AUTOMOTIVE U.S. LLC, Livonia, MI (US)

(72) Inventors: Xing Ping Lin, West Bloomfield, MI (US); Mark Baker, Brighton, MI (US)

(21) Appl. No.: 16/200,845

(22) Filed: Nov. 27, 2018

Related U.S. Application Data
(60) Provisional application No. 62/592,491, filed on Nov. 30, 2017.

(51) Int. Cl. G01S 19/51; G05D 1/00; B60R 25/20

(52) U.S. Cl. CPC G01S 19/51; B60R 25/20; G05D 1/0022

(57) ABSTRACT

A method for locating a vehicle has the following steps:
providing a vehicle-based system comprising a transceiver operatively connected with a vehicle control module;
providing a mobile device having a GPS module and a wireless communication module;
storing on the mobile device a GPS location associated with a location at which the vehicle is parked; and
providing to the user via the mobile device instructions on how to locate the vehicle based on the GPS location stored on the mobile device.

Further, a method for operating a vehicle as well as a system for locating and/or operating a vehicle are shown.

### FIELD OF THE DISCLOSURE

The disclosure relates to a method for locating a vehicle, a method for operating a vehicle as well as a system for locating and/or operating a vehicle.

### BACKGROUND

For operating a vehicle, it is known to use a key or a keyless system, like a fob and an engine push-button. A drawback of these systems is that the key and/or the fob have to be carried around by the user of a car.

Further, the user has to know the location of the parked vehicle. However, the user of the vehicle may have forgotten the location at which the vehicle had been parked or a different person than the person who had parked the vehicle wants to use the vehicle. In this case, information about the location at which the vehicle has been parked is needed. Keys or fobs cannot provide this kind of information.

Thus, there is a need to provide an easy and cost-efficient method for locating a vehicle and operating a vehicle and a system for doing so.

### SUMMARY

For this purpose, a method is provided for locating a vehicle, comprising the following steps:
providing a vehicle-based system comprising a transceiver operatively connected with a vehicle control module;
providing a mobile device having a GPS module and a wireless communication module;
storing on the mobile device a GPS location associated with a location at which the vehicle is parked; and
providing to the user via the mobile device instructions on how to locate the vehicle based on the GPS location stored on the mobile device.

For above purpose, a method for operating a vehicle is provided, comprising the following steps:
providing a vehicle-based system comprising a transceiver operatively connected with a vehicle control module;
providing a mobile device having a wireless communication module for communication with the transceiver;
transmitting at least one instruction for at least one vehicle function, particularly a vehicle entry function, a vehicle security function, a vehicle operation function and/or a vehicle location function from the mobile device to the vehicle-based system via the transceiver and the wireless communication module, in particular using a Bluetooth communications protocol; and
operating the corresponding vehicle function according to the instructions by the vehicle control module.

For example, the desired operation of the vehicle function is selected by the user via the mobile device.

By using a mobile device that virtually every user of a vehicle possesses, key and fobs do not have to be used anymore. Further, as the mobile device is capable of guiding the user to the vehicle, information of the location at which the vehicle has been parked does not have to be memorized by the user or passed on to another user.

The vehicle-based system is in particular a system provided in or on the vehicle.

The mobile device may be a cell phone, a tablet, a laptop or the like.

The instruction to the user may be provided as information about the location of the vehicle, in particular with respect to the location of the mobile device.

In an aspect of the disclosure, the method comprises the following further steps:
transmitting instructions for storing the GPS location from the vehicle-based system to the mobile device via the transceiver and the wireless communication module, in particular using a Bluetooth communication protocol;
receiving the instructions via the mobile device; and
storing on the mobile device the GPS location in response to receiving the instructions.

This way, the mobile device is permanently enabled to locate the vehicle.

In an embodiment of the disclosure, the method comprises the following further steps:
determining via the vehicle-based system when the vehicle is parked, in particular by determining whether the transmission is in park, whether the engine is stopped, whether there is an occupant in the vehicle, whether the doors are locked, and/or whether the security system of the vehicle is armed; and
transmitting the instructions for storing the GPS location in response to determining that the vehicle is parked.

Therefore, it is ensured that the location at which the vehicle is parked is determined precisely.

For example, the instructions for storing the GPS location transmitted from the vehicle-based system to the mobile device include the GPS location associated with a location at which the vehicle is parked, reducing the resources needed at the mobile device.

The GPS location at which the vehicle is parked may be efficiently obtained by determining the GPS location associated with a location at which the vehicle is parked via the GPS module of the mobile device and/or via a vehicle-based GPS receiver, in particular the vehicle based GPS receiver being a GPS receiver of a navigation system of the vehicle.

In order to be able to precisely instruct the user, the instructions to the user on how to locate the vehicle are based on the GPS location stored on the mobile device, on the GPS location of the mobile device determined by the GPS module of the mobile device and/or on cartographic information.

In an aspect of the disclosure, the instruction to the user are provided as soon as the wireless communication module comes within the operating range of the transceiver of the vehicle-based system so that the user is provided with the instructions at the time they are needed.

For example, the instructions are provided as soon as the user reenters the operating range after the user had been outside of the operating range of the transceiver.

In another embodiment, the instructions include commands to lock or unlock at least one of the doors of the vehicle, to arm or disarm a security system of the vehicle, to start or stop the engine of the vehicle and/or to send the location of the vehicle to the mobile device. Thus, a wide variety of functions may be provided by the system.

For ensuring a reliable communication, the wireless communication module and/or the transceiver is a Bluetooth module, in particular the transceiver being a transceiver of an information and/or entertainment system of the vehicle.

For above purpose, further a system for locating and/or operating a vehicle is provided. The system has a vehicle-based system comprising a transceiver operatively connected with a vehicle control module, and a mobile device, wherein the mobile device and the vehicle-based system are configured to jointly perform a method as described above.

### DESCRIPTION OF THE DRAWINGS

Further features and advantages will be apparent from the following description as well as the accompanying drawings, to which reference is made. In the drawings:

FIG. 1 shows schematically a system for locating and/or operating a vehicle according to the disclosure,

FIG. 2 shows a flow-chart of a method for operating a vehicle according to the disclosure,

FIG. 3 shows a system for locating and/or operating a vehicle according to the disclosure in a specific scenario, and

FIGS. 4a and 4b show flow-charts of different embodiments of a method for locating a vehicle according to the disclosure.

### DETAILED DESCRIPTION

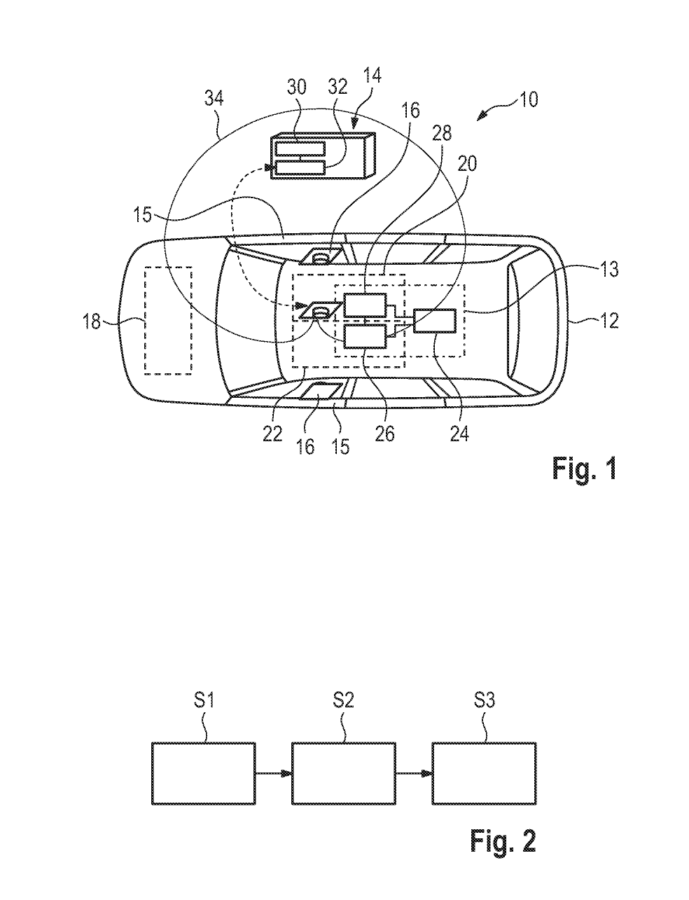

FIG. 1 shows a system 10 for locating and/or operating a vehicle 12 with a vehicle-based system 13 and a mobile device 14.

The vehicle 12 may be a passenger car, a motorbike, or the like.

In the shown embodiment, vehicle 12 is a passenger car having doors 15 with door locks 16, an engine 18—either a combustion engine and/or an electric motor—an information and/or entertainment system 20, a navigation system 22 and a vehicle control module 24.

The navigation system 22 may comprise a GPS receiver 26.

The information and/or entertainment system 20 may comprise a transceiver 28, especially capable of communication via the Bluetooth protocol.

The vehicle control module 24 is connected to the door lock 16, the engine 18, the information and/or entertainment system 20, the navigation system 22 and further components of the vehicle 12, like a security system and/or an occupant detection system.

For example, the GPS receiver 26 and the transceiver 28 are operatively connected with the vehicle control module 24 so that the vehicle control module 24 controls the function of the GPS receiver 26 and the transceiver 28.

The vehicle control module 24 may receive the GPS location from the GPS receiver 26 via a vehicle data bus, e.g. a CAN bus.

In particular at least the vehicle control module 24, the GPS receiver 26 and transceiver 28 form the vehicle based system 13.

Of course, the GPS receiver 26 and the transceiver 28 may be separate from the navigation system 22 and the information and/or entertainment system 20, respectively.

The mobile device 14 is for example a cell phone, a tablet, a laptop or the like. The mobile device 14 comprises a wireless communication module 30, for example a Bluetooth module, and a GPS module 32.

The mobile device 14 is authenticated at the vehicle control module 24, i.e. the specific mobile device 14 has been registered with the vehicle control module 24 as a trusted device.

As indicated in FIG. 1, the transceiver 28 of the vehicle 12 has an operating range 34 and in the situation shown in FIG. 1, the mobile device 14, more specifically the wireless communication module 24 is within the operating range 34. Thus, the transceiver 28 and the wireless communication module 30 may communicate with each other wirelessly, for example by using the Bluetooth protocol.

The user of the mobile device 14, which is at the same time the user of the system 10 and the vehicle 12, may wish to operate the vehicle 12. For example, the user wishes to unlock the doors 15 of the vehicle 12. A flow-chart of such a method for performing this task is shown in FIG. 2.

In a first step (step S1), the user selects at the mobile device 14 the desired operation of one of the functions of the vehicle 12.

For example, vehicle entry functions are provided by the doors 15 with the door lock 16, vehicle security functions are provided by the security system, vehicle operation functions are provided by the engine 18 and vehicle location functions are provided by the GPS receiver 26 and/or the navigation system 22.

In a second step S2 the mobile device 14 transmits an instruction to the vehicle 12 via the wireless communication module 30 and the transceiver 28.

The instruction include the desired operation for the respective function of the vehicle 12. In the exemplary situation, the instructions include the command to the vehicle entry function to unlock the door lock 16.

The vehicle control module 24 operates the respective vehicle function according to the instruction in the next step S3. In the example, the vehicle control module 24 controls the door lock 16 to unlock the door 15.

Thus, the user has operated the vehicle 12 using the system 10, in particular his mobile device 14.

Of course, the instructions and available operations for the user of the system 10 may also include locking the door lock 16 of the doors 15, to arm or disarm the security system, to start or stop the engine 18 and/or to send the location of the vehicle 12 to the mobile device 14.

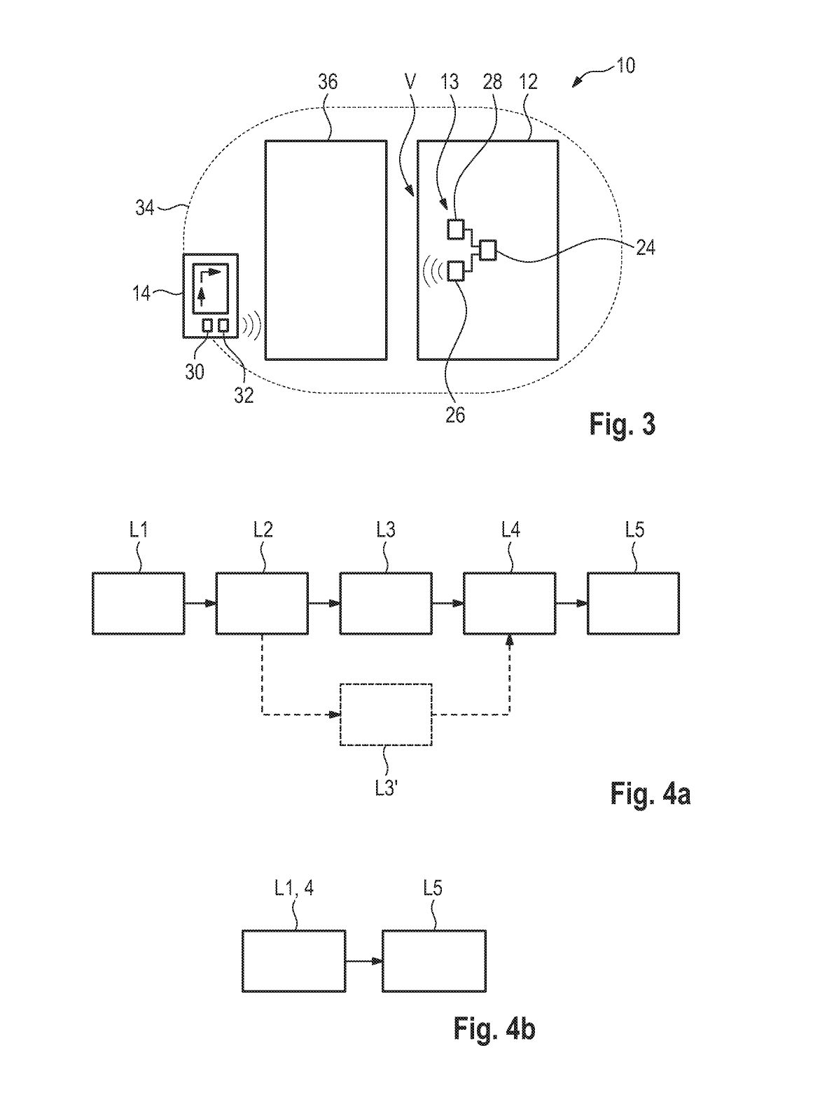

In FIG. 3, the system 10 is shown in a different scenario. The system 10 corresponds to the system 10 as explained above.

The vehicle 12 is parked in a parking lot and the user (not shown) holding the mobile device 14 had been away from his vehicle 12 and wants to return to his vehicle 12. Another vehicle 36 is parked between the vehicle 12 and the user.

The user has just entered the operating range 34 of the transceiver 28 and the mobile device 14 provides instructions to the user on how to locate his vehicle 12. In order to do so, the system 10 is carrying out one of the methods illustrated as a flow-chart in FIG. 4a or 4b.

FIG. 4a illustrates a first embodiment of the method. Before the situation shown in FIG. 3, in a first step L1 the vehicle control module 24 determines that the vehicle 12 has been parked.

This may be done by determining whether the transmission of the vehicle 12 is in park, whether the engine 18 is stopped, whether there is an occupant in the vehicle 12 using the occupant detection system, whether the doors 15 are locked and/or whether the security system of the vehicle 12 is armed.

Any of these indicators or a combination thereof may be used by the vehicle control module 24 to determine that the vehicle 12 is parked.

In this first embodiment, as a reaction to the fact that the vehicle 12 has been parked, the vehicle control module 24 receives the GPS location V from the GPS receiver 26 (step L2). This GPS location V is the GPS location associated with the location at which the vehicle 12 is parked.

In this embodiment, the vehicle control module 24 controls the transceiver 28 to transmit the GPS location V as part of instruction to the wireless communication module 30 and thus to the mobile device 14 (step L3).

The instructions include a command causing the mobile device 14 to store the GPS location V in response to receiving the instructions (step L4). Then, the user departs from the vehicle 12 and leaves the operating range 34.

Alternatively, in step L3′ (shown in the dashed box), instead of including the GPS location V in the instructions sent to the mobile device 14, the instructions may also comprise a command to the mobile device 14 to receive the current location of the mobile device 14 via the GPS module 32 of the mobile device 14 and to store this location as the GPS location V associated with the location at which the vehicle 12 is parked. This may be done because it is assumed that the mobile device 14 is still at the same location of the vehicle 12 or very close to the location when the instructions are received by the mobile device 14.

After some time, the user returns as seen in the situation shown in FIG. 3.

Then, the mobile device 14 provides to the user instructions on how to locate his vehicle 12 (step L5).

The instructions are generated by the mobile device 14 by comparing the GPS location V associated with the location at which the vehicle 12 is parked with the location of the user, i.e. the location of the mobile device 14 received by the GPS module 32 of the mobile device 14.

The mobile device 14 then provides information to the user, for example in form of instructions, how to locate the vehicle 12.

The instructions may be given in a variety of manners, such as by voice, mapping displays, direction indicators (e.g. arrows), or a combination thereof.

In case of a mapping display, the instructions to the user may also be based on cartographic information about the location of the user and the GPS location V of the vehicle 12.

Of course, the instructions could also be an information about the location of the vehicle 12, in particular with respect to the location of the mobile device 14.

In FIG. 3, the instructions are shown in the form of arrows.

The instructions may be provided to the user as soon as the wireless communication module 14 comes within the operating range 34 of the transceiver 28, as shown in FIG. 3.

Of course, because the GPS location V has been stored in the mobile device 14 beforehand, the mobile device 14 may provide instructions earlier than that.

FIG. 4b shows a flow-chart of a second embodiment of the method. The second embodiment corresponds to the first embodiment so that only the differences are discussed below. Same or functionally the same method steps are referred to with the same reference signs.

In this second embodiment, the GPS location V has not been stored on the mobile device 14 at the time the vehicle 12 has been parked or the user has departed from the vehicle 12.

When the user returns to the vehicle 12 and enters the operating range 34 of the transceiver 28, the wireless communication module 30 also enters the operating range 34 and is able to communicate with the transceiver 28.

The vehicle control module 24 determines that the wireless communication module 13 is within the operating range 34 of the transceiver 28 and controls the transceiver 28 to transmit the instructions, now including the GPS location V associated with the location at which the vehicle 12 is parked, to the mobile device 14 (step L1,4).

The mobile device 14 is then able to provide the user with instructions on how to locate the vehicle 12, as explained above (step L5).

Of course, the embodiments disclosed above may be combined. For example if the user approaching the vehicle is not the same as the user that has left the vehicle 12 but carries an authenticated mobile device 14, the method is carried out according to the second embodiment, even though steps L1 to L4 according to the first embodiment have been carried out with the mobile device 14 of the user, who has parked the vehicle 12.

It is also conceivable that the system 10 is paired and/or integrated in a remote keyless entry system (RKE) or a passive keyless entry system (PKE)

1. A method for locating a vehicle, comprising the following steps:
providing a vehicle-based system comprising a transceiver operatively connected with a vehicle control module;
providing a mobile device having a GPS module and a wireless communication module;
storing on the mobile device a GPS location associated with a location at which the vehicle is parked; and
providing to the user via the mobile device instructions on how to locate the vehicle based on the GPS location stored on the mobile device.

2. The method recited in claim 1, comprising the following further steps:
transmitting instructions for storing the GPS location from the vehicle-based system to the mobile device via the transceiver and the wireless communication module;
receiving the instructions via the mobile device; and
storing on the mobile device the GPS location in response to receiving the instructions.

3. The method recited in claim 2, comprising the following further steps:
determining via the vehicle-based system when the vehicle is parked; and
transmitting the instructions for storing the GPS location in response to determining that the vehicle is parked.

4. The method recited in claim 3, wherein determining when the vehicle is parked by at least one of determining whether the transmission is in park, determining whether the engine is stopped, determining whether there is an occupant in the vehicle, determining whether the doors are locked, and determining whether the security system of the vehicle is armed

5. The method recited in claim 2, wherein the instructions for storing the GPS location transmitted from the vehicle-based system to the mobile device include the GPS location associated with a location at which the vehicle is parked.

6. The method recited in claim 1, further comprising determining the GPS location associated with a location at which the vehicle is parked via at least one of the GPS module of the mobile device and a vehicle-based GPS receiver.

7. The method recited in claim 6, wherein the vehicle based GPS receiver being a GPS receiver of a navigation system of the vehicle.

8. The method recited in claim 1, wherein the instructions to the user on how to locate the vehicle are based on at least one of the GPS location stored on the mobile device, on the GPS location of the mobile device determined by the GPS module of the mobile device and on cartographic information.

9. The method recited in claim 1, wherein the instruction to the user are provided as soon as the wireless communication module comes within the operating range of the transceiver of the vehicle-based system.

10. A method for operating a vehicle, comprising the following steps:
providing a vehicle-based system comprising a transceiver operatively connected with a vehicle control module;
providing a mobile device having a wireless communication module for communication with the transceiver;
transmitting at least one instruction for at least one vehicle function from the mobile device to the vehicle-based system via the transceiver and the wireless communication module; and
operating the corresponding vehicle function according to the instructions by the vehicle control module.

11. The method recited in claim 10, wherein the at least one vehicle function is at least one of a vehicle entry function, a vehicle security function, a vehicle operation function and a vehicle location function.

12. The method recited in claim 10, wherein the desired operation of the vehicle function is selected by the user via the mobile device.

13. The method recited in claim 10, wherein the instructions include commands to at least one of lock or unlock at least one of the doors of the vehicle, to arm or disarm a security system of the vehicle, to start or stop the engine of the vehicle and to send the location of the vehicle to the mobile device.

14. The method recited in claim 10, wherein at least one of the wireless communication module and the transceiver is a Bluetooth module.

15. The method recited in claim 10, wherein the wireless communication module and the transceiver using a Bluetooth communication protocol.

16. The method recited in claim 10, wherein the transceiver being a transceiver of at least one of an information system and an entertainment system of the vehicle.

17. The method recited in claim 1, wherein at least one of the wireless communication module and the transceiver is a Bluetooth module.

18. The method recited in claim 1, wherein the wireless communication module and the transceiver using a Bluetooth communication protocol.

19. The method recited in claim 1, wherein the transceiver being a transceiver of at least one of an information system and an entertainment system of the vehicle.

20. A system for at least one of locating and operating a vehicle, comprising:
a vehicle-based system comprising a transceiver operatively connected with a vehicle control module; and
a mobile device;
wherein the mobile device and the vehicle-based system are configured to jointly perform at least one of:
a method for locating a vehicle, comprising the following steps:
providing a vehicle-based system comprising a transceiver operatively connected with a vehicle control module;
providing a mobile device having a GPS module and a wireless communication module;
storing on the mobile device a GPS location associated with a location at which the vehicle is parked; and
providing to the user via the mobile device instructions on how to locate the vehicle based on the GPS location stored on the mobile device;
and
a method for operating a vehicle, comprising the following steps:
providing a vehicle-based system comprising a transceiver operatively connected with a vehicle control module;
providing a mobile device having a wireless communication module for communication with the transceiver;
transmitting at least one instruction for at least one vehicle function from the mobile device to the vehicle-based system via the transceiver and the wireless communication module; and
operating the corresponding vehicle function according to the instructions by the vehicle control module.
